(19) United States
(12) Patent Application Publication
(10) Pub. No.: US 2015/0035401 A1
(43) Pub. Date: Feb. 5, 2015

(54) Motor

(71) Applicant: SUNON ELECTRONICS (FOSHAN) CO., LTD., Foshan City (CN)

(72) Inventor: Alex Horng, Kaohsiung (TW)

(21) Appl. No.: 14/303,678

(22) Filed: Jun. 13, 2014

(30) Foreign Application Priority Data
Jul. 31, 2013 (CN) 201310329088.7

(51) Int. Cl. H02K 7/08

(52) U.S. Cl. CPC H02K 7/08
USPC 310/90

(57) ABSTRACT

A motor includes a base, a stator unit and a rotor. The base includes a shaft tube receiving a sleeve bearing and a positioning member. The positioning member positions the sleeve bearing and includes a hole having a minimal diameter. The stator unit is arranged on the base. The rotor includes a shaft and a permanent magnet. The shaft extends through the hole of the positioning member and rotatably couples with the sleeve bearing. An air gap is formed between the permanent magnet and the stator unit. The shaft has a maximal diameter, and the minimal diameter of the hole of the positioning member is larger than 1.05 times of the maximal diameter of the shaft but is smaller than or equal to two times of the maximal diameter of the shaft.

### BACKGROUND OF THE INVENTION

1. Field of the Invention

The present invention generally relates to a motor and, more particularly, to a motor that includes a sleeve bearing.

2. Description of the Related Art

A conventional motor that is currently available in the market generally includes a base having a shaft tube. A bearing is received in the shaft tube for coupling with a rotor. A stator is fitted around the shaft tube. In such an arrangement, the stator is able to generate alternating electromagnetic field for driving the rotor to rotate. In general, the conventional motor uses a sleeve bearing in order to ensure the smooth operation of the rotor and prolong the service life of the motor.

Please refer to FIG. 1 which shows a conventional motor 8 as disclosed by Taiwan Patent No. 1391568. Motor 8 includes a base 81, a stator unit 82 and a rotor 83. Base 81 includes a metallic shaft tube 811 receiving a sleeve bearing 812 and a positioning member 84 adapted to prevent the sleeve bearing 812 from disengaging from metallic shaft tube 811. Stator unit 82 is press fitted around metallic shaft tube 811. Rotor 83 includes a shaft 831 extending through a through-hole 841 of the positioning member 84 to rotatably couple with sleeve bearing 812.

In the above patent, a gap 85 is formed between a circumferential wall of through-hole 841 and an outer periphery of shaft 831 in order to ensure the smooth operation of rotor 83. However, the gap 85 is too large and the lubricant contained in the sleeve bearing 812 may spill out of shaft tube 811 via gap 85. In other words, the positioning member 84 is able to position sleeve bearing 812 but is unable to prevent the leakage of the lubricant.

Please refer to FIG. 2 which shows a positioning structure for a motor bearing as disclosed by Taiwan Patent No. 1384731. The patent discloses a motor 9 that includes a sleeve bearing 912. Specifically, motor 9 includes a base 91, a stator 92 and a rotor 93. Base 91 includes a shaft tube 911 receiving the sleeve bearing 912 and a positioning member 913. A positioning element 914 is locked at a top end of shaft tube 911. Stator 92 is fitted around the shaft tube 911. Rotor 93 includes a shaft 931 extending through positioning element 914 and positioning member 913 to rotatably couple with sleeve bearing 912.

The above motor 9 mainly relies on positioning member 913 to retain the sleeve bearing 912 while using the positioning element 914 to prevent the sleeve bearing 912 and the positioning member 913 from disengaging from shaft tube 911. Furthermore, when shaft 931 extends through positioning element 914 and positioning member 913, a small gap 94 is formed between shaft 931 and positioning element 914 and positioning member 913. Thus, the lubricant is less likely to spill out of shaft tube 911 via the small gap 94. However, since the gap 94 is too small, the gas of the lubricant oil cannot be easily discharged via gap 94. As a result, the lubricant is not able to cyclically flow between shaft 931 and sleeve bearing 912 in a smooth manner, leading to an inadequate lubricating effect of sleeve bearing 912.

In light of the above, both the conventional motors 8 and 9 encounter a problem where a proper distance cannot be provided between shaft 831 and positioning member 84 (or between shaft 931 and positioning element 914 and positioning member 913). As such, it is difficult to achieve a balance between the preservation of the lubricant and the discharging effect of the gas of the lubricant, resulting in an undesired leakage of the lubricant or an inadequate lubricating effect of the bearing. Disadvantageously, the service lives of motors 8 and 9 are significantly reduced.

### SUMMARY OF THE INVENTION

It is therefore the objective of this invention to provide a motor capable of effectively preventing the loss of the lubricant from inside the shaft tube while allowing the gas of the lubricant to be properly discharged, thereby improving the lubricating effect of the sleeve bearing thereof.

In an embodiment, a motor including a base, a stator unit and a rotor is disclosed. The base includes a shaft tube receiving a sleeve bearing and a positioning member. The positioning member positions the sleeve bearing and includes a hole having a minimal diameter. The stator unit is arranged on the base. The rotor includes a shaft and a permanent magnet. The shaft extends through the hole of the positioning member and rotatably couples with the sleeve bearing. An air gap is formed between the permanent magnet and the stator unit. The shaft has a maximal diameter, and the minimal diameter of the hole of the positioning member is larger than 1.05 times of the maximal diameter of the shaft but is smaller than or equal to two times of the maximal diameter of the shaft.

In a form shown, the base further comprises a base plate portion. The shaft tube is mounted on a face of the base plate portion, and the sleeve bearing is positioned between the positioning member and the base plate portion.

In the form shown, the shaft tube comprises a first end being a closed end, as well as a second end being an open end. The closed end faces the base plate portion. A positioning shoulder is formed on an inner periphery of the shaft tube. The positioning shoulder is adjacent to the open end and coupled with the positioning member.

In the form shown, the positioning member is in the form of a thin, flat plate.

In the form shown, the positioning member comprises an abutting protrusion coupled with an inner periphery of the shaft tube.

In the form shown, the positioning member comprises a recess facing the sleeve bearing.

In the form shown, the motor further comprises a retaining member installed in the shaft tube. An annular groove is formed on an outer periphery of the shaft. The retaining member is engaged into the annular groove.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a cross-sectional view of a conventional motor containing a sleeve bearing.

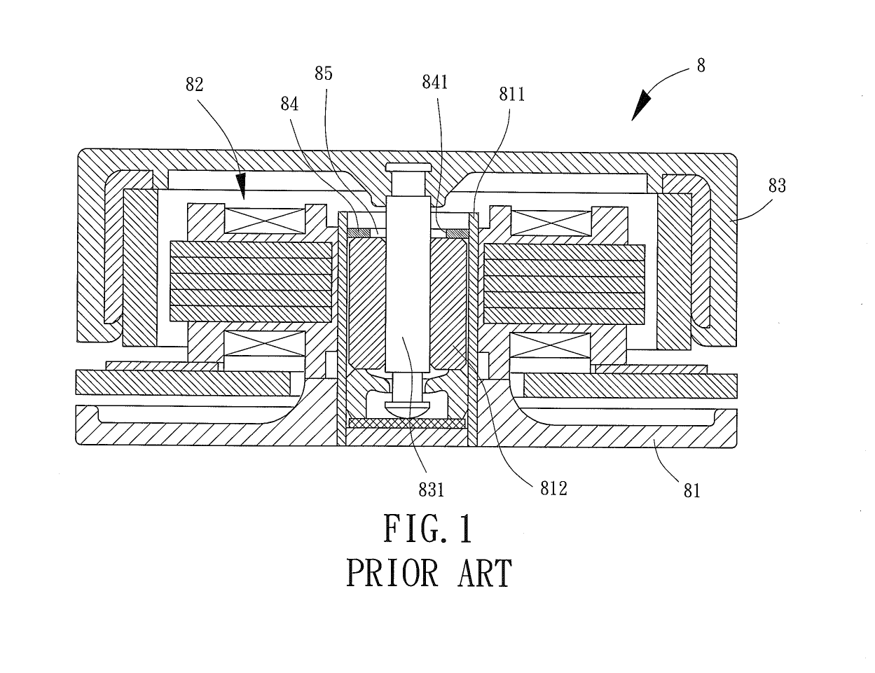

FIG. 2 is a cross-sectional view of another conventional motor containing a sleeve bearing.

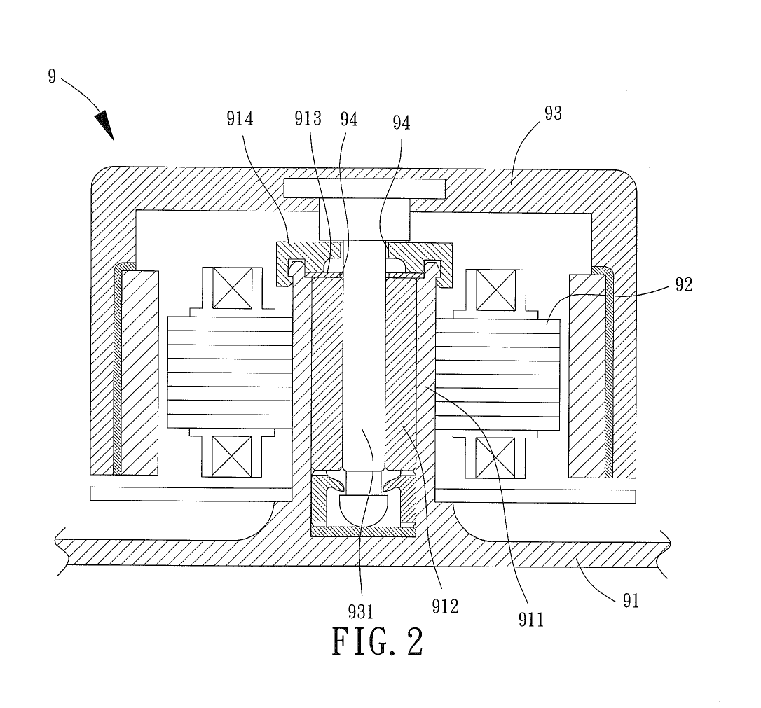

FIG. 3 is a cross-sectional view of a motor according to a first embodiment of the invention.

FIG. 4 is a cross-sectional view of a motor according to a second embodiment of the invention.

FIG. 5 is a cross-sectional view of a motor according to a third embodiment of the invention.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

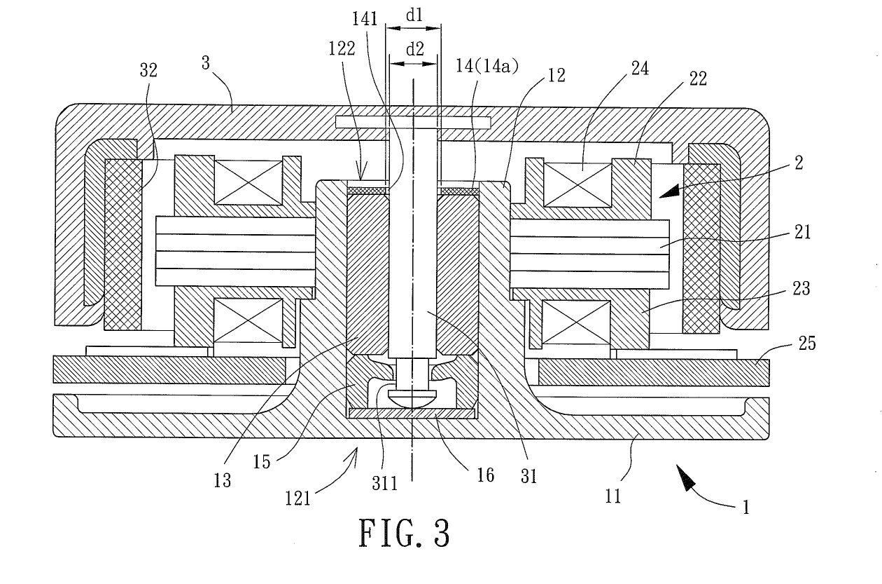

Please refer to FIG. 3 which shows a motor including a base 1, a stator unit 2 and a rotor 3 according to a first embodiment of the invention. Stator unit 2 may be mounted on base 1. Rotor 3 may be rotatably coupled with base 1 so that stator unit 2 is able to drive the rotor 3 to rotate.

Base 1 includes a base plate portion 11, a shaft tube 12, a sleeve bearing 13 and a positioning member 14. Shaft tube 12 is mounted on a face of base plate portion 11. Shaft tube 12 may be integrally formed with base plate portion 11 by way of integral injection molding of plastic material. Alternatively, shaft tube 12 may be a metallic shaft tube that is affixed to base plate portion 11. In the embodiment, shaft tube 12 is integrally formed with base plate portion 11. Furthermore, the sleeve bearing 13 and the positioning member 14 are received in shaft tube 12. Sleeve bearing 13 is positioned between positioning member 14 and base plate portion 11 by the positioning member 14.

Positioning member 14 includes a hole 141 having a minimal diameter d1. Rotor 3 may partially extend through hole 141 and then rotatably couples with sleeve bearing 13. An inner assembly such as a retaining member 15 and a wear-resisting plate 16 may also be installed in shaft tube 12. Retaining member 15 is used to prevent rotor 3 from disengaging from shaft tube 12. Wear-resisting plate 16 is used to provide smooth rotation of rotor 3.

Stator unit 2 is mounted on base 1 and may be fitted around shaft tube 12 of base 1. Stator unit 2 may be of any structure capable of driving rotor 3 to rotate. In this embodiment, stator unit 2 includes a plurality of silicon steel plates 21 (or simply a single silicon steel plate), an upper insulation sleeve 22, a lower insulation sleeve 23 and a coil 24. The silicon steel plates 21 are stacked with each other. Upper insulation sleeve 22 and lower insulation sleeve 23 are coupled with the uppermost and lowermost silicon steel plates 21, respectively. An enamel copper wire is wound around the outer peripheries of upper insulation sleeve 22 and lower insulation sleeve 23 to form the coil 24. Coil 24 may also be electrically connected to a driving circuit 25. Driving circuit 25 may be directly mounted on base 1. Alternatively, driving circuit 25 may also be arranged outside of the motor and a power wire is used to connect to driving circuit 25 for power transmission.

Rotor 3 includes a shaft 31 and a permanent magnet 32. Shaft 31 extends through the hole 141 of positioning member 14 to rotatably couple with sleeve bearing 13. When retaining member 15 is provided, an annular groove 311 may be formed on an outer periphery of shaft 31. In this arrangement, retaining member 15 may be engaged into annular groove 311 to prevent rotor 3 from disengaging from shaft tube 12 of base 1 without affecting the rotation of shaft 31. In addition, an air gap is formed between permanent magnet 32 and stator unit 2. After coil 24 is electrified, alternating electromagnetic field may be generated via the air gap, driving the rotor 3 to rotate. The detailed structures of stator unit 2 and rotor 3, as well as the principle on how stator unit 2 drives rotor 3 to rotate, are not described herein, as they can be readily understood by one skilled in the art.

Shaft 31 includes a maximal diameter d2. In this regard, the motor in this embodiment may have the dimensional relation that the minimal diameter d1 of hole 141 of positioning member 14 is larger than 1.05 times of the maximal diameter d2 but is smaller than or equal to two times of the maximal diameter d2. This can be expressed as (1.05*d2)<d1□(d2+d2). In such a dimensional relation, the outer periphery of shaft 31 may be spaced from a peripheral wall of hole 141 of positioning member 14 at a proper distance. Under the proper distance, the gap between the outer periphery of shaft 31 and the peripheral wall of hole 141 will not be too large, so that the lubricant of the sleeve bearing 13 is less likely to spill out of shaft tube 12 via the gap while the gas of the lubricant can be smoothly discharged. Thus, preservation of the lubricant and smooth discharging effect are achieved at the same time. Advantageously, the lubricant is able to cyclically flow between shaft 31 and sleeve bearing 13 in a smooth manner, providing an improved lubricating effect.

Referring to FIG. 3 again, positioning member 14 is in the form of a thin, flat plate 14a according to the first embodiment of the invention. Shaft tube 12 includes a first end being a closed end 121, as well as a second end being an open end 122. The closed end 121 faces base plate portion 11 and keeps the lubricant inside shaft tube 12. Thus, since the positioning member 14 is thin when in the form of a thin, flat plate 14a, the height of shaft tube 12 can be reduced. Thus, the volume of the motor is reduced.

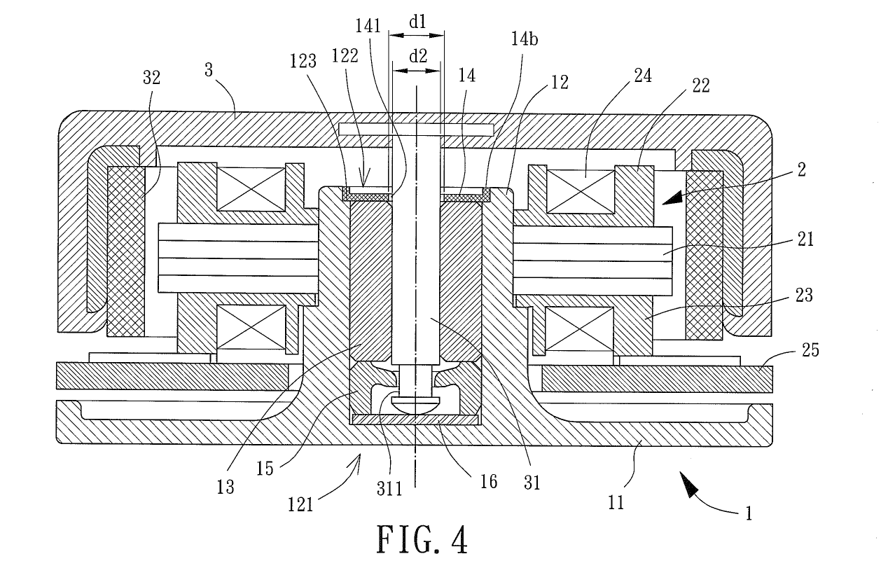

Referring to FIG. 4, positioning member 14 is shown according to a second embodiment of the invention. In this embodiment, positioning member 14 differs from that of the first embodiment in that a positioning shoulder 123 is formed on an inner periphery of shaft tube 12. Positioning shoulder 123 is adjacent to open end 122 (namely, more close to the open end 122 than the closed end 121). Positioning member 14 may be coupled with positioning shoulder 123 and includes an abutting protrusion 14b axially extending towards open end 122. In such an arrangement, when positioning member 14 is coupled with positioning shoulder 123, abutting protrusion 14b may couple with the inner periphery of shaft tube 12. This effectively increases the coupling area between positioning member 14 and shaft tube 12, thereby reinforcing the coupling effect therebetween.

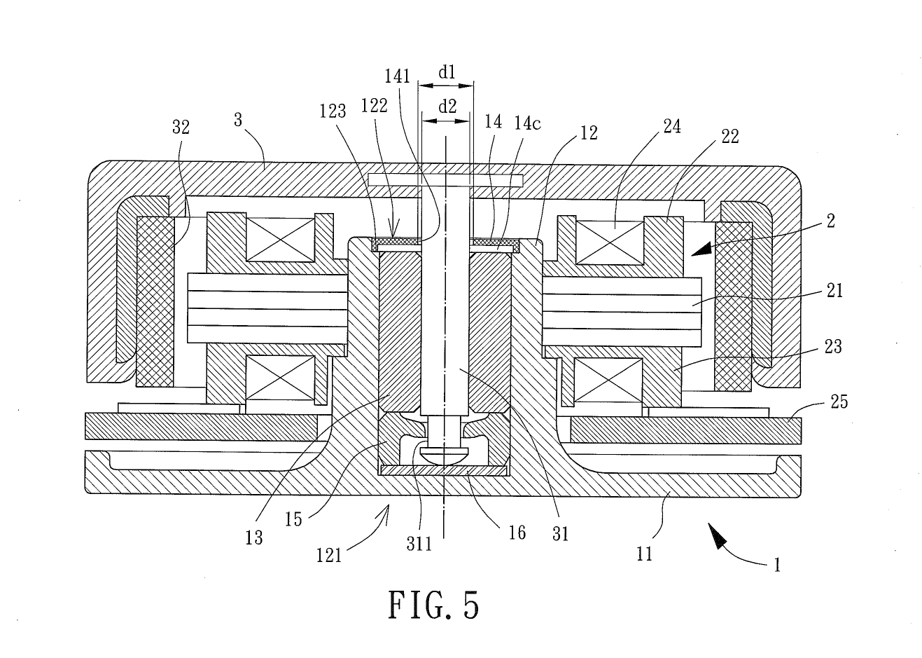

Referring to FIG. 5, positioning member 14 is shown according to a third embodiment of the invention. In this embodiment, positioning member 14 differs from that of the first embodiment in that a positioning shoulder 123 is formed on an inner periphery of shaft tube 12. Positioning shoulder 123 is adjacent to open end 122 (namely, more close to the open end 122 than the closed end 121). Positioning member 14 may be coupled with positioning shoulder 123 and includes a recess 14c facing sleeve bearing 13. In such an arrangement, when positioning member 14 is coupled with positioning shoulder 123, recess 14c may serve as a storage space for the lubricant, improving the preservation of the lubricant.

Based on the above dimensional relation that the minimal diameter d1 of hole 141 of positioning member 14 is larger than 1.05 times of the maximal diameter d2 of shaft 31 but is smaller than or equal to two times of the maximal diameter d2, the balance between the preservation of the lubricant and the discharging effect of the gas of the lubricant can be attained, prolonging the service life of the motor.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A motor comprising:
a base having a shaft tube, wherein the shaft tube receives a sleeve bearing and a positioning member, wherein the positioning member positions the sleeve bearing and comprises a hole, and wherein the hole has a minimal diameter;
a stator unit arranged on the base; and
a rotor having a shaft and a permanent magnet, wherein the shaft extends through the hole of the positioning member and rotatably couples with the sleeve bearing, and wherein an air gap is formed between the permanent magnet and the stator unit;
wherein the shaft has a maximal diameter, and wherein the minimal diameter of the hole of the positioning member is larger than 1.05 times of the maximal diameter of the shaft but is smaller than or equal to two times of the maximal diameter of the shaft.

2. The motor as claimed in claim 1, wherein the base further comprises a base plate portion, wherein the shaft tube is mounted on a face of the base plate portion, and wherein the sleeve bearing is positioned between the positioning member and the base plate portion.

3. The motor as claimed in claim 2, wherein the shaft tube comprises a first end being a closed end, as well as a second end being an open end, wherein the closed end faces the base plate portion, wherein a positioning shoulder is formed on an inner periphery of the shaft tube, wherein the positioning shoulder is adjacent to the open end, and wherein the positioning member is coupled with the positioning shoulder.

4. The motor as claimed in claim 1, wherein the positioning member is in the form of a thin, flat plate.

5. The motor as claimed in claim 1, wherein the positioning member comprises an abutting protrusion coupled with an inner periphery of the shaft tube.

6. The motor as claimed in claim 1, wherein the positioning member comprises a recess facing the sleeve bearing.

7. The motor as claimed in claim 1, further comprising a retaining member installed in the shaft tube, wherein an annular groove is formed on an outer periphery of the shaft, and wherein the retaining member is engaged into the annular groove.
